(19) United States
(12) Patent Application Publication
(10) Pub. No.: US 2015/0201560 A1
(43) Pub. Date: Jul. 23, 2015

(54) Combine Harvester Rotor Drive Device

(71) Applicant: Limited Liability Company Combine Plant Rostselmash, Rostov-On-Don (RU)

(72) Inventors: Sergey Temilovich Demirdzhi, Rostov-On-Don (RU); Alexander Viktorovich Evseev, Rostov-On-Don (RU); Vadim Viktorovich Bolshakov, Rostov-On-Don (RU); Sergey Alexandrovich Pokotilo, Rostov-On-Don (RU); Igor Nikolaevich Grabko, Rostov-On-Don (RU)

(73) Assignee: Limited Liability Company Combine Plant Rostselmash, Rostov-On-Don (RU)

(21) Appl. No.: 14/374,151

(22) PCT Filed: Aug. 19, 2013
(86) PCT No.: PCT/RU2013/000717

§ 371 Date: Jul. 23, 2014

(30) Foreign Application Priority Data
Aug. 21, 2012 (RU) 2012136167

(51) Int. Cl. A01F 12/56

(52) U.S. Cl. CPC A01F 12/56

(57) ABSTRACT

The disclosure relates to the drive and rotation speed adjustment for a threshing rotor of rotary grain harvesters. The technical result, intended to be achieved by the invention, is an improvement in the reliability of the rotor drive due to its design simplification, an increase of torque transferred from the engine to the rotor and assured regulation of the speed of the stepless rotor. The technical result is obtained by including a hydraulic cylinder, ratchet wheel and lock, wherein the hydraulic cylinder installed on the rotor drive gearbox housing controls lock blocking of the ratchet wheel by a mechanical linkage, and the ratchet wheel is fixed with a shall of the inside planetary gear. Selection of transfer ratios for gearbox gears allows the harvester weight to be reduced by excluding the transmission gear box from the rotor drive gearbox.

### FIELD OF THE INVENTION

The invention relates to agricultural engineering, specifically to arrangements of the drive and rotation speed adjustment for a threshing rotor in a threshing separating device of rotary grain harvesters.

### STATE OF THE ART

The method and arrangement of rotor drive with V-belt variable-speed. gear (harvesters Don-2600, Don-2600R made by Combine Plant Rostselmash LLC, etc.) are known. [1]

An arrangement of the rotor drive using a summing gearbox with a transmission gear, in which the speed is changed within the range of two stages is also known (harvester Torum-740 made by Combine Plant Rostselmash LLC, etc.) [2, 3].

The closest analogue of the claimed arrangement of the rotor drive with speed change is the system of harvester Torum740 according to patent RU2370695C2 [3].

The mechanism of a rotor drive is provided by torque transfer from an internal-combustion engine via a transfer gearbox and cardan shaft to the summing gearbox and then, depending on a chosen working range of the rotor drive gearbox, the transmission gear rotor is actuated with speed adjustment within the operating range of rotor speeds. Moreover, the rotor is coaxially fixed with the output shaft of the rotor drive gearbox,

The disadvantages of the closest analogue of the claimed arrangement of the rotor drive are as follows:

1) low reliability due to arrangement design complexity and the necessity of gear shilling when choosing optimum rotor speed values for given harvesting conditions, that is impossible due to gearbox gear tooth on tooth and unacceptable while emergency starting after rotor blocking, as slipping out, i.e. space blocking between rotor and cage by reverse rotor rotation is eliminated only at first (from two) speed range;
2) insufficient torque transferred from engine to rotor conditioned by the fact that, while slipping out, the hydrostatic motor is not blocked and its torque limits the transfer moment from the engine to the rotor;
3) coaxial fixed location (connection) of the output gearbox shaft and the rotor rotation axis that reduces the reliability of the connection under impact loads.

### SUMMARY OF THE INVENTION

The technical result, intended to be achieved by the invention, is an improvement in the reliability of the rotor drive due to its design simplification, an increase in torque transferred from the engine to the stepless rotor, and an improved regulation of the speed of the stepless rotor.

The specified technical result is obtained due to the novel arrangement of the grain harvester rotor drive. The rotor drive comprises a mechanically connected transfer gearbox driven from a harvester engine, a coupling clutch, a cardan shaft and a rotor drive gearbox. The rotor drive, gearbox includes a hydraulically connected hydrostatic pump and a hydrostatic motor, bevel gear, idler gear, planetary gear, output shall with hub for coaxial joining with the rotor. Moreover, the hydrostatic pump is mechanically connected with the cardan shaft and hydraulically connected with the hydrostatic motor. The hydrostatic motor is mechanically connected with an inside planetary gear, wherein a bevel gear, idler gear and planetary gear are mechanically connected with an output shaft. The rotor is kept from blocking by introducing a hydraulic cylinder with a lock and ratchet wheel. While activated, the lock blocks the ratchet wheel which is fixed to the central planetary gear by a shaft. A planetary gear output shaft is connected to the rotor by a splined cap. The speed of the stepless threshing rotor may be changed by selecting transfer ratios for the hydrostatic motor speed and inside planetary gear. Moreover, in one embodiment, the output shaft of the rotor drive gearbox is confined to the rotor rotation axis by a splined cap and toothed coupling at an angle. In one embodiment, the hydrostatic motor speed change is obtained due to operating fluid flow change by means of a hydrostatic pump in the hydraulic system.

### BRIEF DESCRIPTION OF DRAWINGS

The claimed arrangement is illustrated by way of example by the following drawings.

FIG. 1 shows a consolidated structural layout of a rotor drive arrangement in accordance with an embodiment of the invention; and

FIG. 2 shows a detailed, structural layout of the rotor drive arrangement in accordance with an embodiment of the invention.

### DETAILED DISCLOSURE

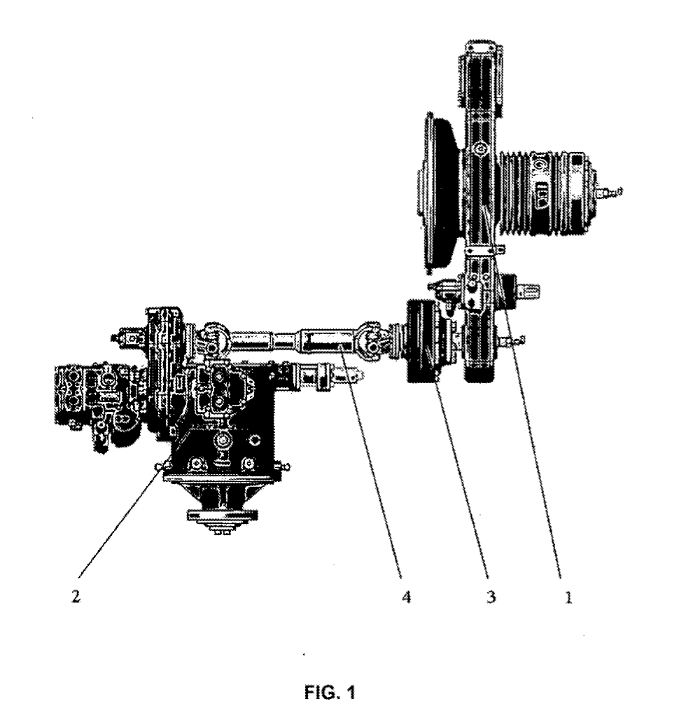

A consolidated structural layout of the rotor drive arrangement from an internal-combustion engine includes the following structural assemblies in the embodiment illustrated in FIG. 1:
1—transfer gearbox;
2—rotor drive gearbox;
3—friction clutch coupling;
4—cardan shaft.

The motion of the rotor drive is transmitted, from the internal-combustion engine, via the transfer gearbox 1 to the rotor drive gearbox 2, via the friction clutch coupling 3 connected to the cardan shall 4.

This mechanism engages the grain harvester rotor drive with the hydrostatic mechanical gear. Moreover, the hydrostatic mechanical gear brings the rotor into operation and permits the adjustment of the speed of the stepless rotor. A friction clutch coupling is brought into operation by the transfer gearbox. The friction clutch coupling output is mechanically connected to a rotor drive gearbox input. A shaft of a hydrostatic pump and bevel gear to planetary gear hollow wheel are brought into rotation via a cylindrical gear. The hydrostatic pump is hydraulically connected to a hydrostatic motor. The hydrostatic motor is connected with a bevel, gear of a central planetary gear. A pinion cage (output shaft) of the planetary gear is connected by a spline joint to the rotor. A ratchet mechanism is installed on a shaft of the central planetary gear. In the gearbox casing (housing), provision is made for a hydraulic cylinder to stop the ratchet mechanism with a lock in case of emergency i.e. the rotor slipping out.

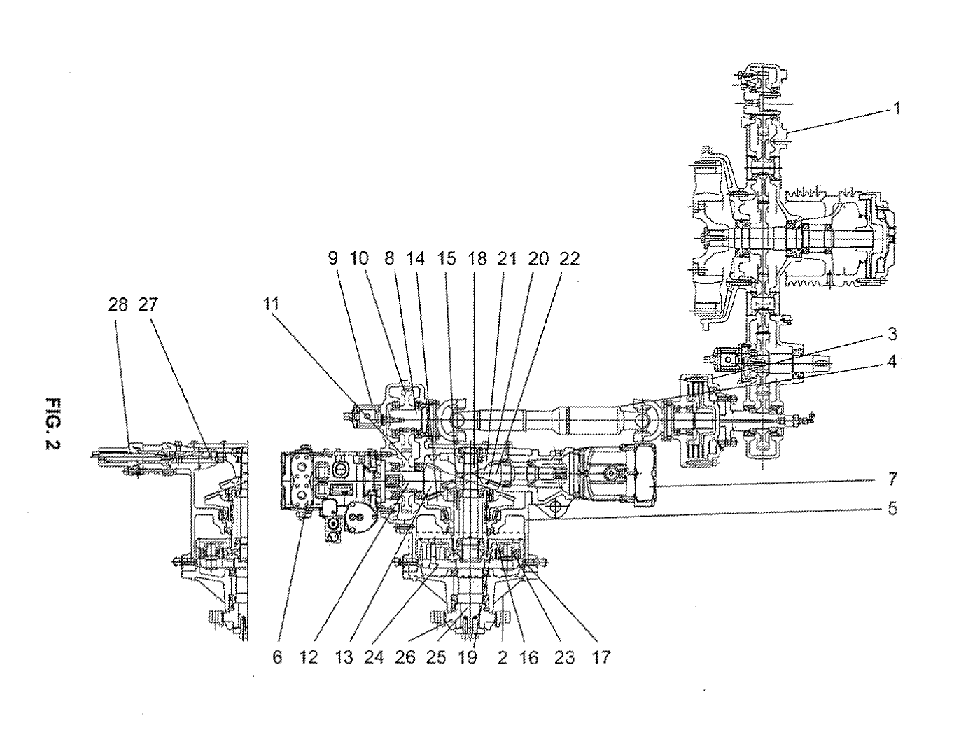

A detailed structural layout of the rotor drive arrangement from the engine includes the following assemblies in the embodiment illustrated in FIG. 2:
1—transfer gearbox;
2—rotor drive gearbox;
3—friction clutch coupling;
4—cardan shaft;
5—housing;
6—hydrostatic pump;
7—hydrostatic motor;
8—input shaft;
9—hydraulic pump of cooling system;
10, 11—cylindrical gears;
12—drive shaft;
13, 14—bevel gearwheels;
15—hollow shaft;
16—outside gear;
17—planetary gear;
18—shaft;
19—central gear
20—bevel gearwheel;
21—ratchet wheel;
22—bevel gearwheel;
23—satellite gear;
24—pinion cage:
25—Output shaft;
26—splined cap;
27—lock:
28—hydraulic cylinder.

The arrangement operates as follows. The transfer gearbox 1 brings the friction clutch coupling 3 into operation, which engages the rotor drive gearbox 2 via a cardan shaft 4 in its turn. A hydrostatic pump 6 and a hydrostatic motor 7, which are mechanically connected with the rotor drive, are fastened to a housing 5 of the rotor drive gearbox 2. The hydrostatic pump 6 is hydraulically connected with hydraulic tube assemblies, which are not shown in FIG. 2) with the hydrostatic motor 7 in order to bring it into operation.

The rotor drive gearbox 2 has input in the form of an input shaft 8, which brings the cardan shaft 4 into operation. An input shaft 8 of the rotor drive gearbox 2 is directly connected with a shaft of a hydraulic pump for driving a cooling system 9. On input shaft 8 is a cylindrical gear 10, which brings into rotation the second cylindrical gear 11 installed on a drive shaft 12 of the hydrostatic pump 6 on which a first bevel gearwheel 13 is installed without cranking. The first bevel gearwheel 13 brings the second bevel gearwheel 14 into operation, which is installed on a hollow shaft 15 and engages the outside gear 16 and the planetary gear 17.

On a shaft 18 is a planetary gear 17 and central gear 19, a further bevel gearwheel 20 and ratchet wheel 21 which are fixed on the shaft without rotation. The bevel gearwheel 20 engages another bevel gearwheel 22, which is fixed on the shaft of the hydrostatic motor 7 without rotation. Accordingly, bevel gearwheels 20 and 22 form an angular drive.

The planetary gear 17 has several satellite gears 23, which are located between the outside gear 16 and the central gear 19 and are fixed rotationally on satellite gear pinion cage 24. The pinion cage 24 of the satellite gears 23 has an output shaft 25, which provides the output of the planetary gear 17, on which splined cap 26 is installed, due to which the rotor can skew with regard to the output shaft 24, protecting the structure from impact loads.

A ratchet wheel 21 is used to block the planetary gear 17 and the central gear 19 while emergency starting after the rotor has been blocked by processing a mass in the thresher. In order to stop while starting, a lock 27 pulled out by hydraulic-cylinder rod 28 installed on the gearbox casing (i.e. housing 5) is engaged with the ratchet wheel 21. Unlike prior art mechanisms in which all torque from the engine is imposed on the rotor, in the present invention, the hydrostatic motor is not blocked and, thus, limits torque transferred to the rotor.

Arrangements of a locking mechanism for the rotor drive include a hydraulic cylinder 28, a ratchet wheel 21 and a lock 27, which engages the hydraulic cylinder 28 of the interlocking hydrostatic motor 7 while emergency starting and is intended, to transfer higher torque from the engine to the rotor to slip out the rotor after blocking, thereby ensuring a more reliable slipping out process. Selection of transfer ratios for gearbox gem provides the following advantages: (i) reducing the weight of the harvester by excluding the gearbox from the rotor drive gearbox; (ii) preventing gearwheel tooth on tooth contact when range shifting; (iii) allowing the operator to adjust the rotor speed; and (iv) preventing the blocking of the space between the rotor and the cage, to ensure that there always exists a sufficient working space for the rotor drive. Lubrication of structural assemblies for the claimed arrangement without pressure discharge improves the reliability of the arrangement.

This invention has been described in terms of specific embodiments, implementations and configurations which are intended to be exemplary only. Persons of ordinary skill in the art will appreciate, having read this disclosure, that many obvious variations, modifications and refinements may be made without departing from the inventive concept(s) presented herein. The scope of the exclusive right sought b the Applicant(s) is therefore intended to be limited solely by the appended claims.

### LIST OF USED REFERENCES

1. Self-Propelled Grain Harvesters Don-2600 and Rice and Grain Harvesters Don-2600-R. Operating and Maintenance instruction RSM-12 OI.—Rostov-on-Don: Combine Plant Rostselmash LLC, 2000.

2. Self-Propelled Grain Harvester RSM-181 Torum-740 Operating and Maintenance Instruction RSM-181 OI.—Rostov-on-Don: Combine Plant Rostselmash LLC, 2008.

3. Patent RU2370695C2, publication Oct. 20, 2009.

1. An arrangement of a grain harvester rotor drive having a mechanically connected transfer gearbox driven by a harvester engine, a coupling clutch, a drive shaft and a rotor drive gearbox including as hydraulically connected hydrostatic pump and a hydrostatic motor, a bevel gear, an idler gear, a planetary gear, and an output shaft with a hub for coaxially connecting the rotor, wherein the hydrostatic pump is mechanically connected with the drive shaft and is hydraulically connected with the hydrostatic motor, wherein the hydrostatic motor is mechanically connected with an inside planetary gear, wherein the bevel gear, the idler gear and the planetary gear are mechanically connected with an output shaft, characterized in that the rotor drive comprises a hydraulic cylinder with a lock and a ratchet wheel wherein activation of the lock blocks the ratchet wheel fixed to a central planetary gear by a shaft, wherein a planetary gear output shaft is connected to the rotor by a splined cap, and wherein a rotor speed is changeable by selection of transfer ratios of a hydrostatic motor speed and the inside planetary gear.

2. The arrangement as defined in claim 1 characterized in that the output shaft of the rotor drive gearbox is confined to a rotor rotation axis by the splined cap and a toothed coupling at an angle.

3. The arrangement as defined in claim 2 characterized in that the hydrostatic motor speed changes in response to a change of pressure developed by the hydrostatic pump in a hydraulic feed system.
